(19) United States
(12) Patent Application Publication
(10) Pub. No.: US 2009/0228781 A1
(43) Pub. Date: Sep. 10, 2009

(54) DOCUMENT MANAGEMENT APPARATUS AND METHOD, AND STORAGE MEDIUM STORING DOCUMENT MANAGEMENT PROGRAM

(75) Inventor: Satoshi Imai, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/391,598

(22) Filed: Feb. 24, 2009

(30) Foreign Application Priority Data
Mar. 6, 2008 (JP) 2008-056626

(51) Int. Cl. G06F 17/00

(52) U.S. Cl. 715/234

(57) ABSTRACT

A document management apparatus includes a generating unit for generating an editor's structured document from a preparer's structured document by additionally providing a document structure, which represents the structure of the preparer's structured document, with an editor's document structure that shares pages contained in the document structure; and an editing unit for editing the generated editor's structured document.

### BACKGROUND OF THE INVENTION

1. Field of the Invention

The present invention relates to a document management apparatus and method for editing structured documents, and to a storage medium storing such a document management program.

2. Description of the Related Art

Generally, when a large document is created, often a plurality of preparers create documents individually and these documents are then assembled into a single document, or a single preparer creates documents using applications that differ according to type of content and assembles these into a single document. If a specification is taken as an example, there are instances where the document can be an extremely large one of several thousand pages. When such a voluminous document is created, the operation generally is carried out in line with the steps below.

(1) Initially, each preparer creates a document individually.

(2) When the documents are more or less completed, they are gathered together and arranged into the format of a specification.

(3) The pages in the overall specification are interchanged and the overall content and appearance of the specification are adjusted.

Conventionally, when step (3) is reached, it is required that each individual preparer find the portion for which he or she is responsible from the large specification and then return to step (1) to make any revisions. As a result, finding the locations to be revised and then performing step (2) again takes time. Thus a disadvantage of this method is that the activity requires a prolonged period of time.

The specification of Japanese Patent Laid-Open No. 2002-091949 discloses an information processing apparatus in which a single unified electronic document can be created from a plurality of different material electronic documents and editing can be performed easily while the relationship between the material electronic documents and unified electronic document is maintained. In accordance with Japanese Patent Laid-Open No. 2002-091949, however, the pages of the material electronic documents and the pages of the unified electronic document are separate from each other and the unified electronic document is created while correlating these pages. Accordingly, since the pages per se are separate from one another, the file size of the structured document becomes very large.

### SUMMARY OF THE INVENTION

The present invention provides a document management apparatus capable of improving the efficiency with which source documents are edited and of suppressing an increase in the file size of an assembled structured document.

The present invention in its first aspect provides a document management apparatus for generating a structured document for an editor based upon a structured document for a preparer and editing the structured document for the editor, the apparatus comprises, a generating unit for generating the structured document for the editor from the structured document for the preparer by additionally providing a document structure, which represents the structure of the structured document for the preparer, with a document structure for the editor that shares pages contained in the document structure; and an editing unit for editing the generated structured document for the editor.

The present invention in its second aspect provides a document management method executed in a document management apparatus for generating a structured document for an editor based upon a structured document for a preparer and editing the structured document for the editor, the method comprises the steps of generating the structured document for the editor from the structured document for the preparer by additionally providing a document structure, which represents the structure of the structured document for the preparer, with a document structure for the editor that shares pages contained in the document structure; and editing the generated structured document for the editor.

The present invention in its first aspect provides a computer-readable storage medium storing a document management program for generating a structured document for an editor based upon a structured document for a preparer and editing the structured document for the editor, the program causes a computer to perform functions of generating the structured document for the editor from the structured document for the preparer by additionally providing a document structure, which represents the structure of the structured document for the preparer, with a document structure for the editor that shares pages contained in the document structure; and editing the generated structured document for the editor.

In accordance with the present invention, the efficiency with which source documents are edited can be improved and an increase in the file size of an assembled structured document can be suppressed.

Further features of the present invention will become apparent from the following description of exemplary embodiments with reference to the attached drawings.

### BRIEF DESCRIPTION OF THE DRAWINGS

FIG. 1 is a diagram illustrating the configuration of a document management system according to an embodiment of the present invention;

FIG. 2 is a diagram illustrating the configuration of an ordinary information processing apparatus applied to a document management apparatus in this embodiment;

FIG. 3 is a diagram illustrating the functional configuration of this document management system;

FIG. 4 is a diagram useful in describing the relationship between preparers and documents;

FIG. 5 is a diagram illustrating the structure of a pre-assembly document created upon delivery of documents created by individual preparers;

FIG. 6 is a diagram illustrating the structure of a post-assembly document;

FIG. 7 is a flowchart illustrating a procedure up to creation of a post-assembly document;

FIG. 8A is a first diagram illustrating an example of coding of a post-assembly document;

FIG. 8B is a diagram illustrating an example of folder organization;

FIG. 9 is a second diagram illustrating an example of coding of a post-assembly document;

FIG. 10 is a diagram useful in describing rearrangement of B_DOC;

FIG. 11 is a diagram illustrating an example of coding of a rearranged post-assembly document;

FIG. 12 is a diagram illustrating data of a post-assembly document that has been stored in memory in this embodiment;

FIG. 13 is a diagram illustrating an example of screens displayed to an editor in a document management apparatus;

FIG. 14 is a diagram useful in describing changeover of references in a post-assembly document;

FIG. 15 is a diagram illustrating an example of coding of a post-assembly document in which a reference destination has been changed over;

FIG. 16 is a diagram useful in describing an operation for deleting a page;

FIG. 17 is a diagram useful in describing a case where editing of a designated page in a document created by a preparer A is requested;

FIG. 18 is a flowchart illustrating processing for requesting editing of a designated page described in FIG. 16;

FIG. 19 is a diagram illustrating an example of coding of a post-assembly document in which a reference destination has been changed;

FIG. 20 is a diagram useful in describing a case where a designated page of a document has been added on by a preparer A; and

FIG. 21 is a flowchart illustrating processing executed when a designated page of a document is added on by a preparer A.

### DESCRIPTION OF THE EMBODIMENTS

Preferred embodiments of the present invention will now be described in detail with reference to the drawings. It should be noted that identical structural elements are designated by like reference characters.

### First Embodiment

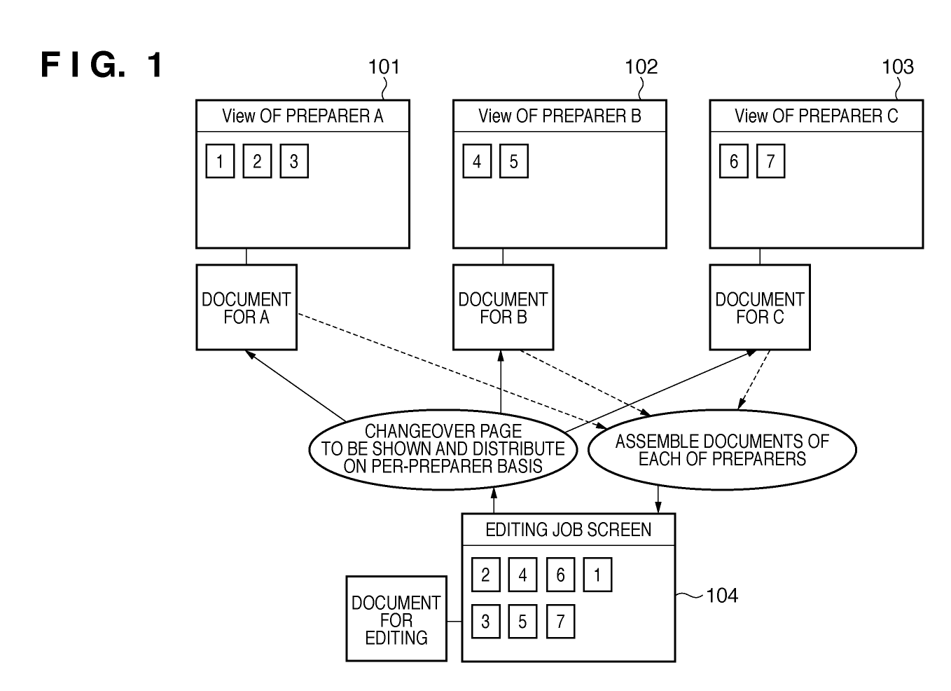

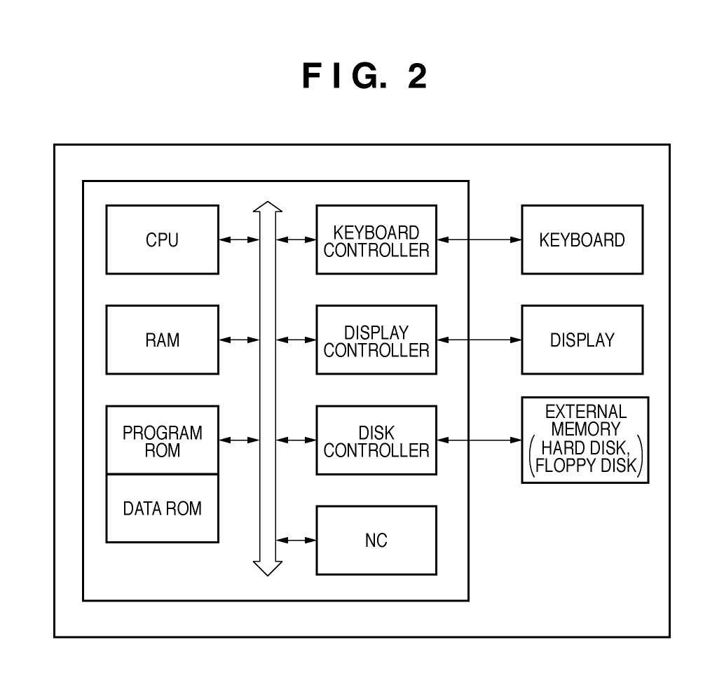

FIG. 1 is a diagram illustrating the configuration of a document management system according to an embodiment of the present invention. As illustrated in FIG. 1, this document management system includes a personal computer 101 used when a preparer A creates a document; a personal computer 102 used when a preparer B creates a document; a personal computer 103 used when a preparer C creates a document; and a document management apparatus 104 used by an editor. The editor uses the document management apparatus 104 to assemble the documents created by preparers A to C and to perform operations necessary for interchanging pages, etc., thereby creating a single document. The assembled and completed document is re-distributed to the preparers A to C. The documents created by preparers A, B and C will be referred to as documents for A, B and C, respectively. Further, the document that has been assembled by the document management apparatus 104 and subjected to operations necessary for interchanging of pages will be referred to as a document for editing. Here the term “document” signifies a structured document in which the data structure has the form of a tree. For example, an XPS file is used as document in this embodiment. Further, an information processing apparatus of ordinary construction, such as a personal computer having a CPU and memories such as a RAM and hard disk shown in FIG. 2, is used as the document management apparatus 104 in this embodiment. Work screens for the respective preparers A, B, C and editor are shown in FIG. 1. When the editor in this document management system determines documents and pages requiring revision, the editor distributes these to the preparers. The document for editing in this embodiment is a document having such a structure that pages shown to each of the preparers can be changed over. Using a view screen or the like, each preparer can view and edit only the document created by this preparer per se. This eliminates labor in terms of a preparer having to find a document (or pages) created by this preparer in the large document obtained by assembling multiple documents and makes it possible to reduce the risk that a document created by another preparer will be edited accidentally.

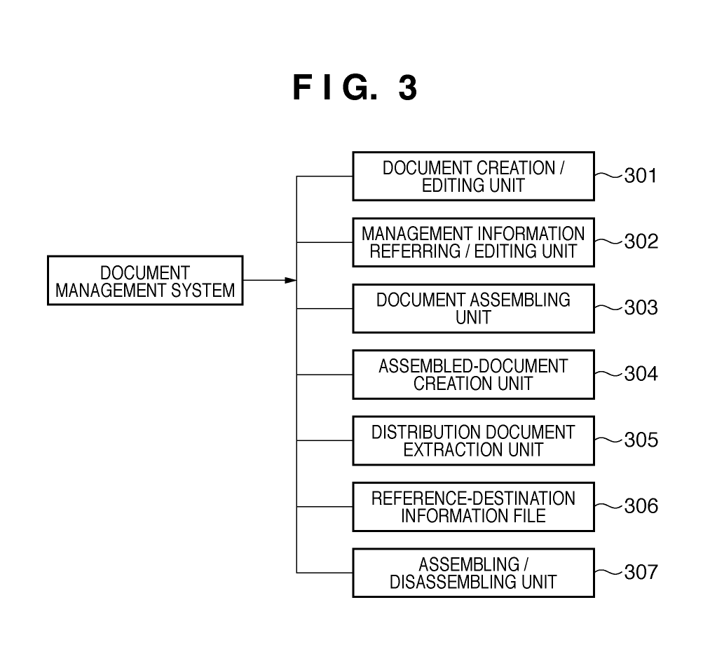

FIG. 3 is a diagram illustrating the functional configuration of this document management system. A document creation/editing unit 301 is implemented by the CPUs of the personal computers 101 to 103 in FIG. 1 and creates a structured document put into the form of a tree structure. Using the document creation/editing unit 301, each of the preparers initially creates pages, creates a branch in the tree structure as necessary and adds on the pages. A management information referring/editing unit 302 to an assembling/disassembling unit 307 are implemented by processing executed by the CPU of the document management apparatus 104 in FIG. 1. The management information referring/editing unit 302 manages information such as the correspondence between delivered documents and preparers. Based upon this information, the user of the system can determine which preparer created a page constituting the assembled document. A document assembling unit 303 assembles a plurality of source documents created by the document preparers and creates a document (a pre-assembly document) put into the form of a tree structure. An assembled-document creation unit 304 creates a post-assembly document having a tree structure different from that of the pre-assembly document in order to perform page-interchange editing with regard to the pre-assembly document created by the document assembling unit 303. The pre-assembly document and post-assembly document will be described later.

In a case where it is necessary to revise a post-assembly document, a distribution document extraction unit 305 creates a tree structure anew in units of the documents created by each of the preparers or in units of pages requiring revision. A reference-destination information file 306 changes over a reference destination in the tree structure of a source document, pre-assembly document and post-assembly document, etc., among the above-mentioned tree structures, thereby making it possible to change the tree structure and page content desired to be shown. Using the ZIP method or the like, an assembling/disassembling unit 307 compresses the tree-structured documents created as described above and stores the compressed documents in a memory, etc., as a single file. Further, by decompressing a compressed file using the assembling/disassembling unit 307, reference can be had to the compressed documents within.

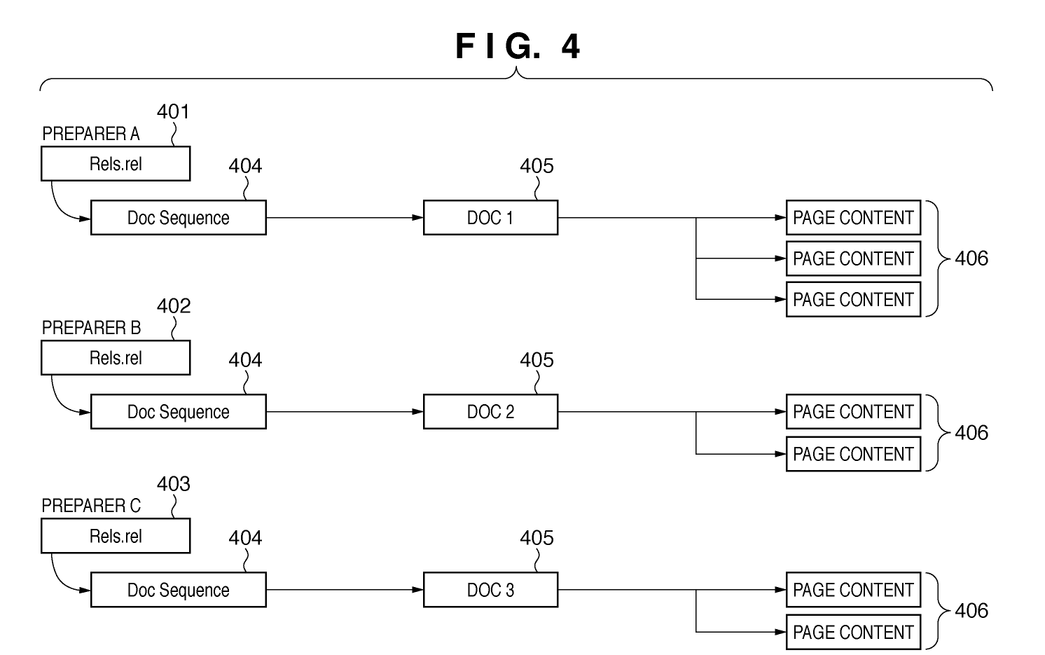

FIG. 4 is a diagram useful in describing the relationship between preparers and documents. Source documents 401, 402, 403 created individually by preparers A, B, C, respectively, correspond to the documents for A, B, C, respectively, shown in FIG. 1. In this embodiment, XPS files are used as the source documents. Accordingly, the source documents have a hierarchical structure composed of respective elements 404 (DocSequence), elements 405 (DOC1 to DOC 3) and elements 406 (page content). Reference to element 404 (DocSequence) is had from “Rels.rel” (root), reference to element 405 (DOC1 to DOC 3) is had from element 404, and reference to element 406 (page content) is had from element 405.

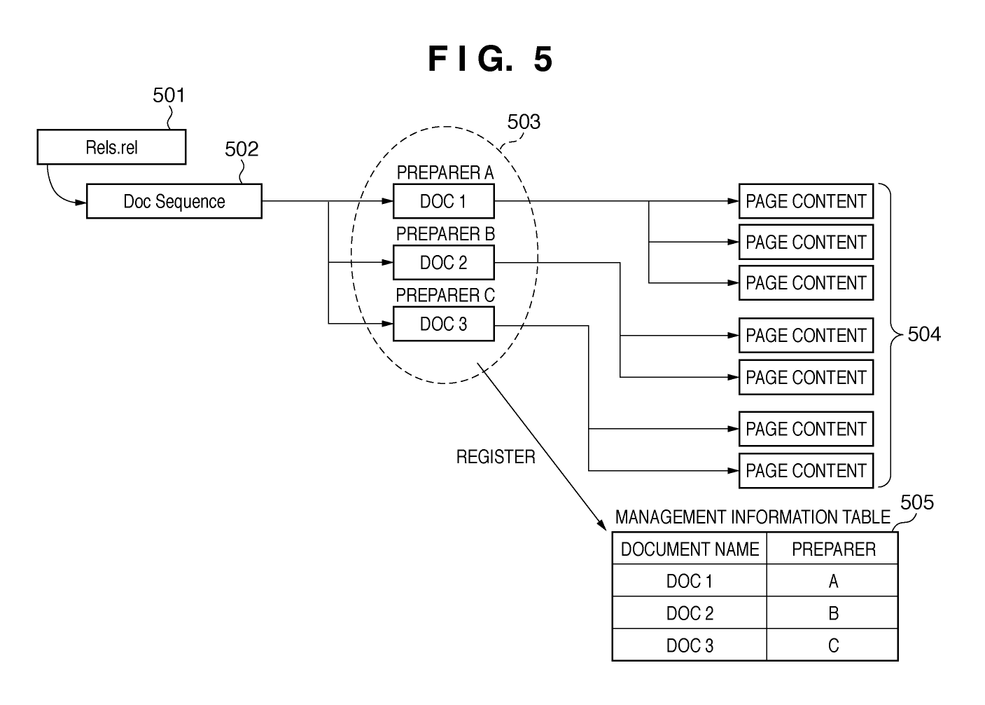

FIG. 5 is a diagram illustrating the structure of a pre-assembly document created upon delivery of documents created by individual preparers. Documents DOC1 to DOC3 (elements 405) created by the respective preparers are delivered and a pre-assembly document provided with the structure shown in FIG. 5 is created. The structure of a pre-assembly document 501 (Rels.rel), element 502 (Doc Sequence) and element 504 (page content) corresponds to the structure of the source document 401 (Rels.rel), element 404 (Doc Sequence) and element 406 (page content) shown in FIG. 4. Further, an element 503, which includes the documents DOC1 to DOC3 created by the preparers A to C, respectively, corresponds to elements 405 in the structure shown in FIG. 4. With regard to delivery of documents, and by way of example, first DOC1 is delivered and the tree structure that will serve as a base is registered. Next, when DOC2 is delivered, reference information of DOC2 is added to element 502 (Doc Sequence). Finally, when DOC3 is delivered, reference information of DOC3 is added to element 502 (Doc Sequence). When the pre-assembly document 501 is delivered, the document names and preparers are correlated in a separate management information table 505 and stored in a memory or the like.

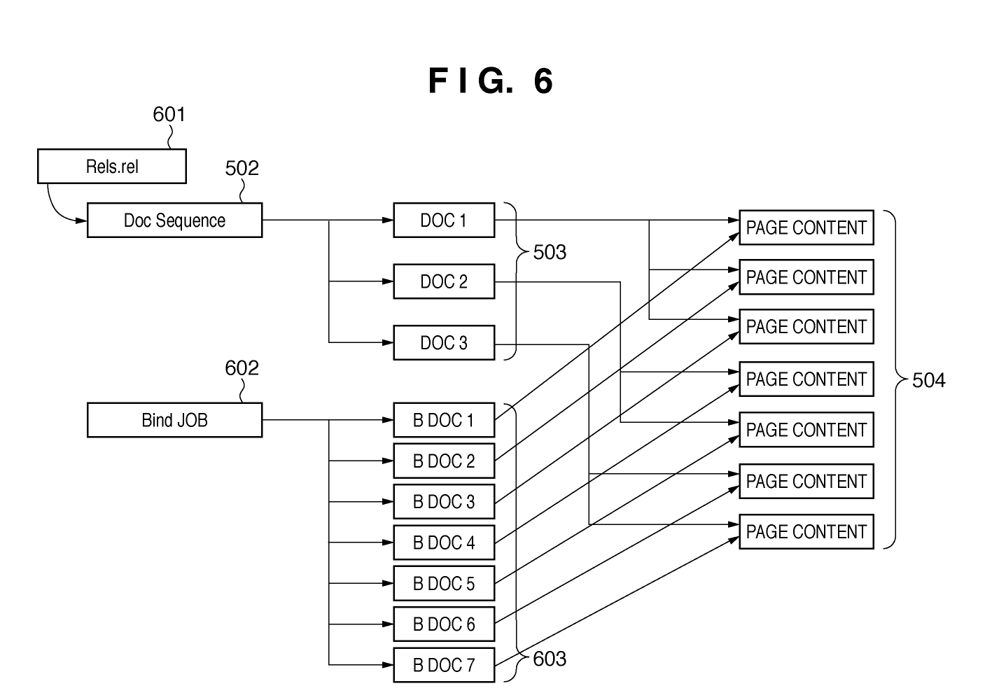

FIG. 6 is a diagram illustrating the structure of a post-assembly document. In this embodiment, the document management apparatus 104 generates a post-assembly document 601, which has a hierarchical structure of the kind shown in FIG. 6, from the pre-assembly document shown in FIG. 5. The post-assembly document 601 is different from the pre-assembly document 501 in the following respect: there is reference from “Rels.rel” to element 602 (BindJOB), reference from element 602 (Bind JOB) to element 603 (B_DOC1 to B_DOC7) and reference from element 603 (B_DOC1 to B_DOC7) to page content. In FIG. 6, reference from “els.rel” to element 602 (Bind JOB) is not illustrated. This will be described later. The number of elements 603 (B_DOC1 to B_DOC7) and the number of items of page content are the same. In this embodiment, the structured document for the editor shown in FIG. 6 is generated by adding the editor's document structure that follows “BindJOB” (element 602) to the document structure representing the structure of the preparer's structured document shown in FIG. 5. Further, in this embodiment, page content is shared by the preparer's document structure and editor's document structure, as illustrated in FIG. 6.

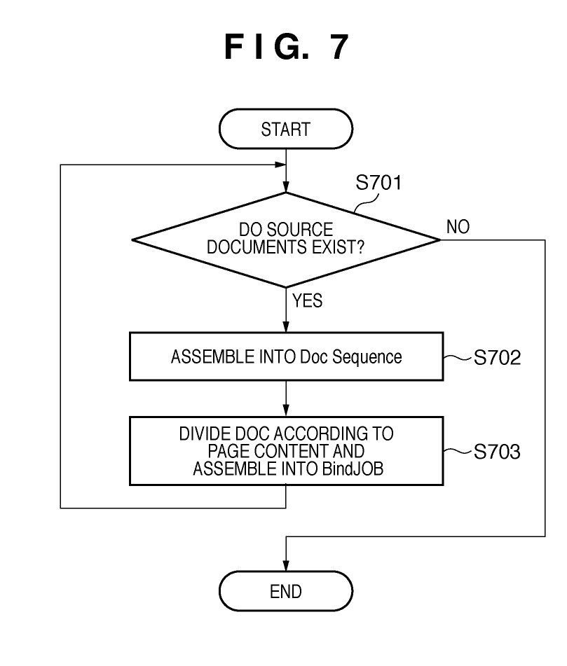

FIG. 7 is a flowchart illustrating a procedure up to creation of a post-assembly document. First, at step S701, the document management apparatus 104 determines whether the source documents 401 to 403 created by the preparers A to C for creating a post-assembly document exist. This processing is exited if it is determined that the source documents do not exist. If it is determined that the source documents exist, on the other hand, then control proceeds to step S702. Here element 405 (DOC2) possessed by the source document is added to element 502 (Doc Sequence), which is shown in FIG. 5, as a reference destination. This processing is equivalent to processing for adding the document for B of preparer B to the document for A of preparer A. For example, only the portion of reference from the data “<FixedDocumentSequence>” of the document for B to element 503 (DOC2) is copied and this is added onto the portion “<FixedDocumentSequence>” of the document for A. The “<FixedDocumentSequence>” will be described later. Processing for adding element 405 (DOC3) possessed by the source document to element 502 (Doc Sequence), which is shown in FIG. 5, as a reference destination also is executed in similar fashion. Next, at step S703, “<FixedDocument>” (described later) three pages of which are referred to by DOC1 is divided, element 503 being divided in such a manner that this will become one element 603 with respect to one item of page content. Furthermore, this is assembled into element 602 (BindJOB) and the structure of the post-assembly document 601 shown in FIG. 6 is obtained.

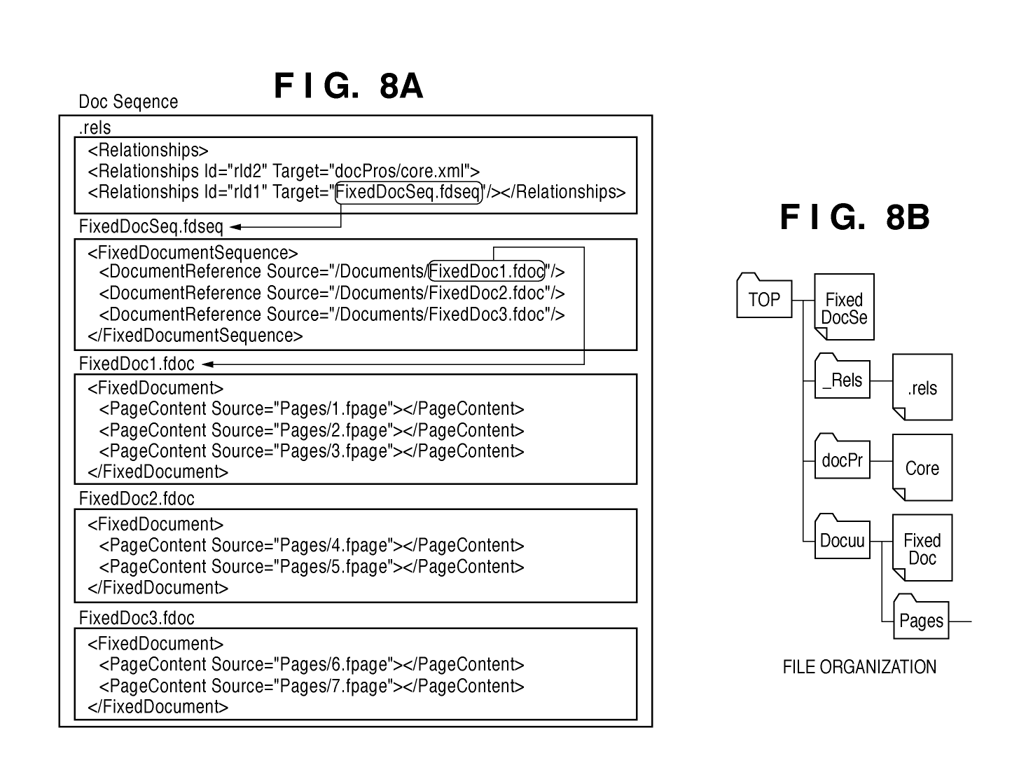

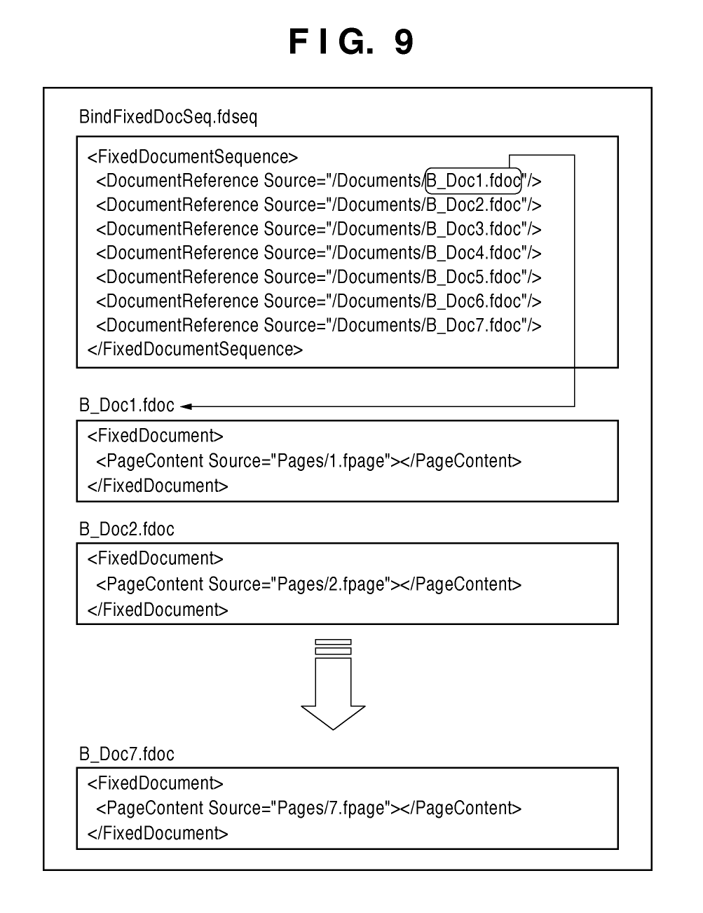

FIG. 8A and FIG. 9 are diagrams illustrating an example of coding of a post-assembly document. FIG. 8A and FIG. 9 actually represent a single file of continuous descriptions. In the arrangement shown in FIG. 8A, the fact that reference is had to “FixedDocSeq.fdseq” (element 502) is set forth in .rels file (post-assembly document 601) in which “<Relationships>” has been entered. In this embodiment, the way that the tree structure of the post-assembly document 601 is shown to the editor can be changed by changing over this reference destination. The fact that reference is had to DOC1 to DOC3 (element 503) is set forth in “FixedDocSeq.fdseq” in which “<FixedDocumentSequence>” has been entered. In “FixedDoc1.fdoc” (element 503) in which “<FixedDocument>” has been entered, the fact that reference is had to page content (element 504) is set forth.

The fact that reference is had to element 602 of post-assembly document 601 and element 603 is set forth in FIG. 9. As illustrated in FIG. 8A, there is no description that “<Relationships>” refers to “<BindFixedDocSeq.fdseq>”. If necessary, however, this entry (description) can be made and reference can be made to this. That reference is had to all elements 603 (B_DOC1 to B_DOC7) is set forth in “BindFixedDocSeq.fdseq”. Furthermore, the fact that reference is had to one page's worth of page content is set forth in, e.g., “B_Doc1.fdoc” (element 603) that mentions “<FixedDocument>”. In this embodiment, each file constituting the post-assembly document 601 is stored in the memory of document management apparatus 104 as the folder organization shown in FIG. 8B.

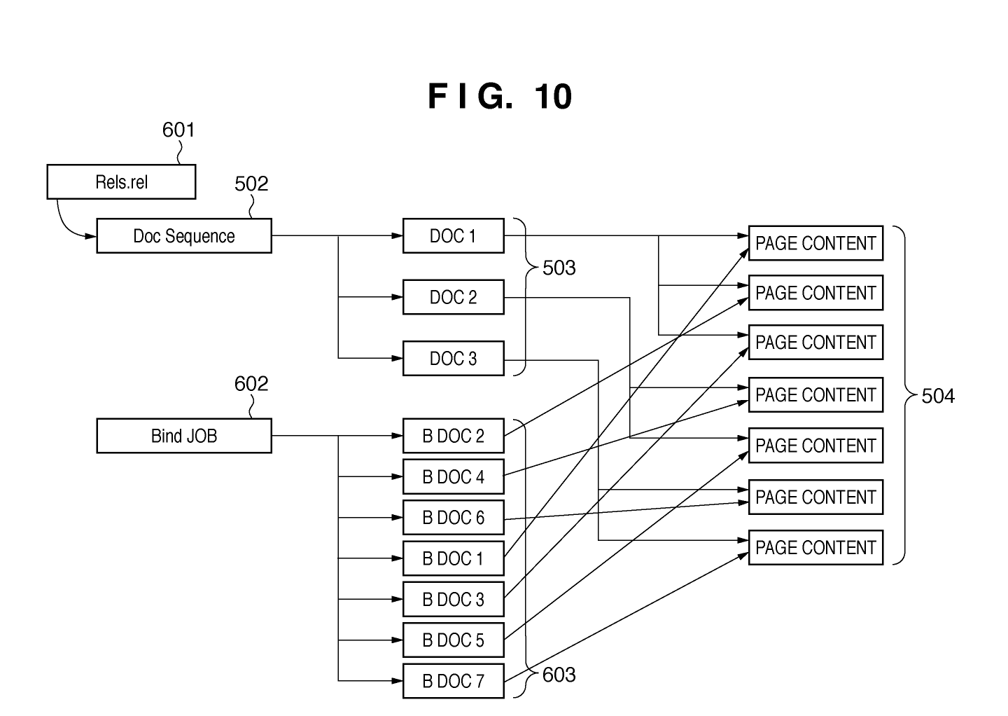

FIG. 10 is a diagram useful in describing rearrangement of B_DOC. In this document management system, the editor can rearrange the pages of the post-assembly document 601 freely in the document management apparatus 104. If a change in the arrangement of the pages is designated by the editor, then the arrangement of the elements 603 is changed, as shown in FIG. 10, in accordance with the page order. In FIG. 10, the pages are rearranged to “2”, “4”, “6”, “1”, “3”, “5”, “7”. In this case, no change is necessary with regard to elements 502, 503, 504, as shown in FIG. 10.

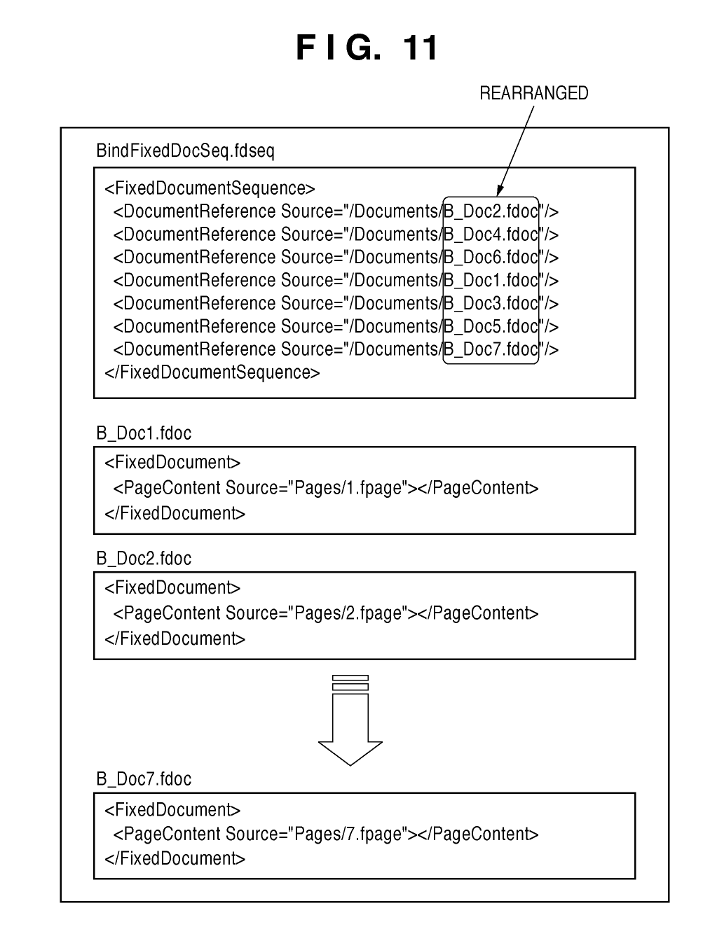

FIG. 11 is a diagram illustrating an example of coding of a rearranged post-assembly document. With regard to the rearrangement of pages, a change can be made by rearranging the order of description on the lines of B_DOC1 to 7 in “<FixedDocumentSequence>”.

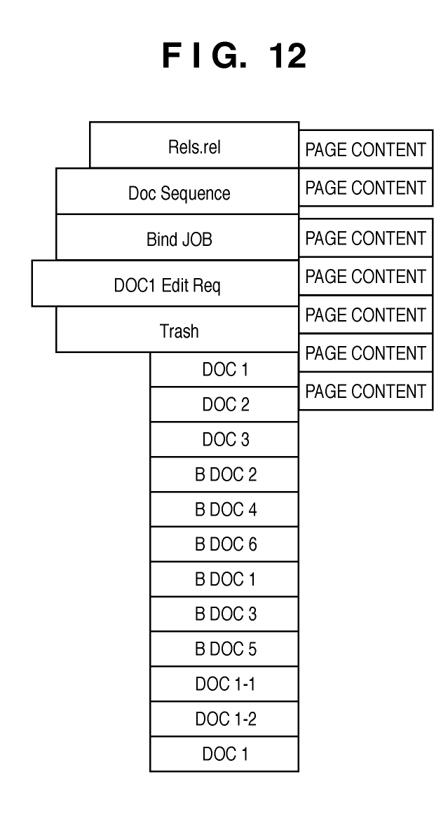

FIG. 12 is a diagram illustrating data of a post-assembly document that has been stored in memory in this embodiment. According to this embodiment, the post-assembly document is subjected to required processing (described later) by the editor and is then stored in memory in the format shown in FIG. 12. In a case where the document is stored, generally it is compressed by a compression method such as ZIP. “DOC1 Edit Req”, “Trash”, “DOC1-1” and “DOC1-2” shown in FIG. 12 will be described later. In this embodiment, as illustrated in FIG. 12, only structural elements in the structured document have been stored. It is unnecessary to separately store a file defining the structure. Further, since page content is shared by source documents and structured document that has been assembled, an increase in file size can be suppressed.

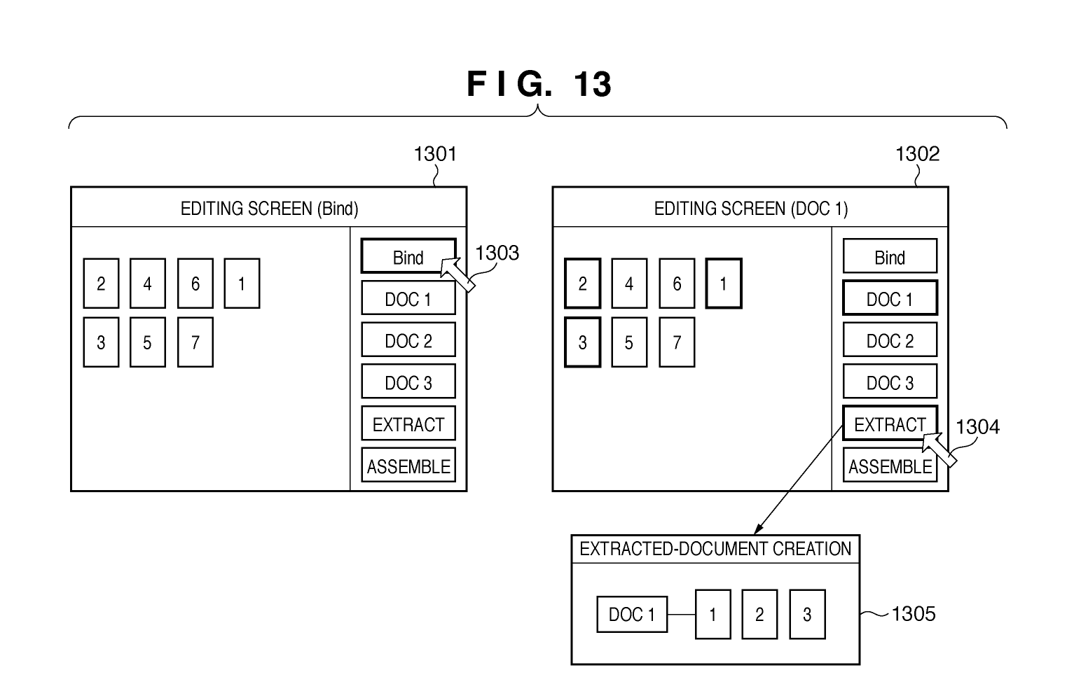

FIG. 13 is a diagram illustrating an example of screens displayed to an editor in a document management apparatus. As shown in FIG. 13, the document management apparatus 104 is capable of displaying a screen 1301 and a screen 1302 as screen manipulated by the editor. If the editor presses a “Bind” button on screen 1301, the processing shown in FIG. 7 is executed, the post-assembly document 601 is generated and all pages are displayed on the screen (this is not illustrated). If the editor freely changes the order of the pages on the screen, then a display is presented as indicated by screen 1301. At this time the post-assembly document 601 takes on the structure shown in FIG. 11. Further, by using the screen 1301, the editor can perform operations such as inserting new pages and deleting pages.

If the editor presses a “DOC1” button on screen 1301, then the pages that have been created by preparer A are displayed, as indicated by screen 1302. In FIG. 13, the display is such that the first to third pages created by preparer A can be understood. Now consider a case where the editor requests preparer A, for example, to make a revision. In this case, if the editor presses an “EXTRACT” button 1304 on screen 1302, then only the pages that preparer A created are gathered together and displayed on an extracted-document creation screen 1305. After confirming the content of this screen, the editor issues an edit request by a selection dialog using an ordinary OK button or the like displayed separately. When this is done, the preparer A recognizes receipt of the edit request in the system and is capable of using the personal computer 101 to edit the document created by preparer A himself. Upon completing editing, preparer A sends the edited document for A back to the document management apparatus 104.

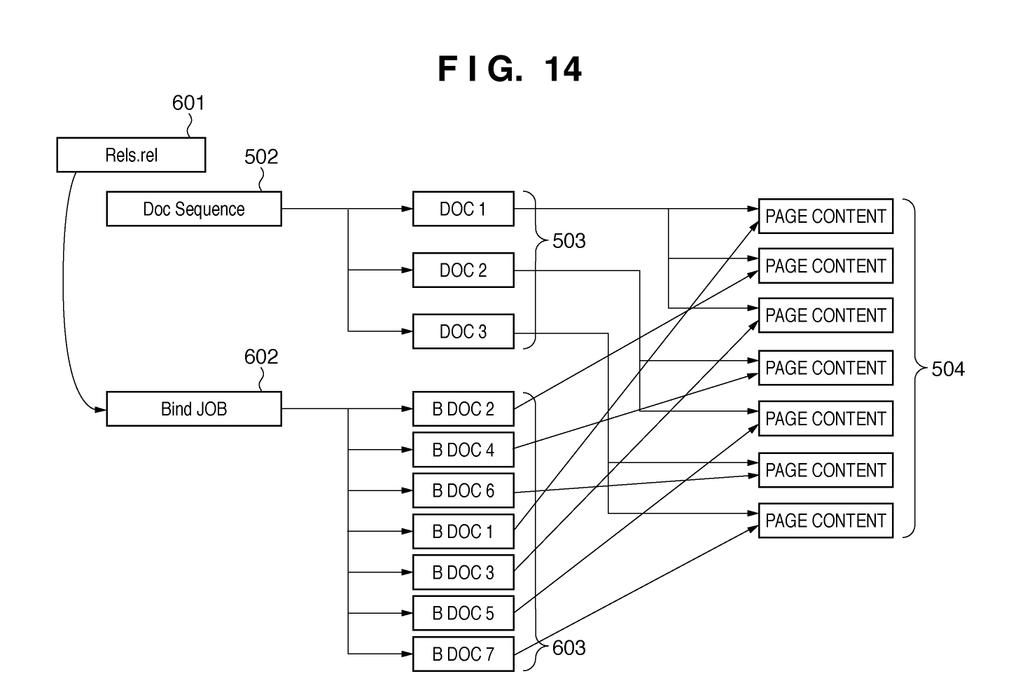

FIG. 14 is a diagram useful in describing changeover of references in a post-assembly document. As already described, when the editor presses the “Bind” button 1303 on the screen 1301 shown in FIG. 13, all pages are displayed on the screen. At this stage the reference destination of “Rels.rel” (post-assembly document 601) shown in FIG. 6 is changed over from “DocSequence” to “BindJOB”. In this embodiment, the structure (tree structure) displayed as the target of editing can be changed by changing over the reference destination from “Rels.rel”, i.e., the root of this hierarchical structure.

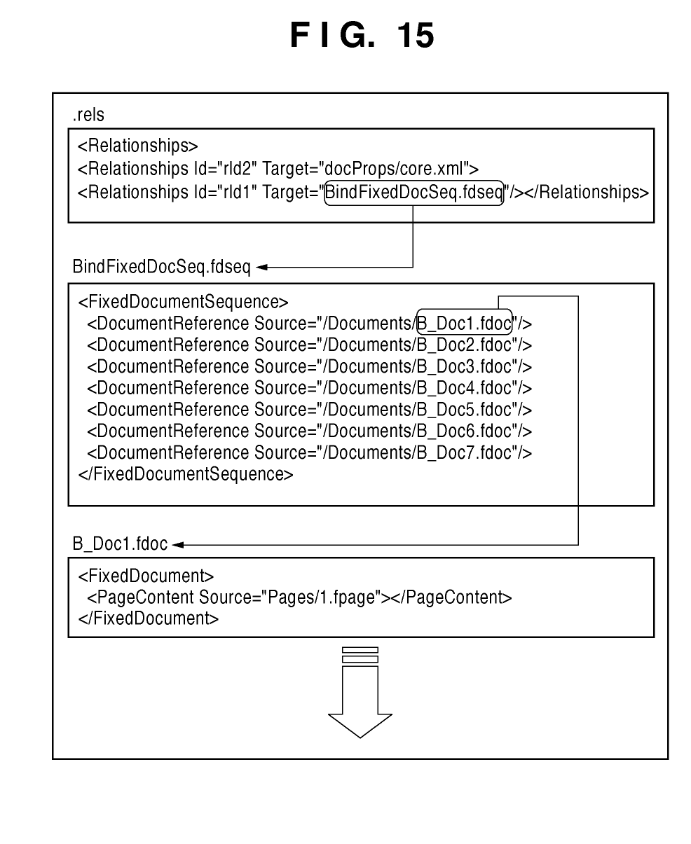

FIG. 15 is a diagram illustrating an example of coding of a post-assembly document in which a reference destination has been changed over. In this embodiment, if the reference destination is changed to “BindJOB”, then the entry “Target” of “<Relationships>” is changed to ‘“Target=“BindFixedDoc.Seq.fdseq”’. The reference destinations of all items of page content held by “BindJOB” are set forth in “BindFixedDocSeq.fdseq” to which reference has been had, and each refers to “<FixedDocument>” of “B_Doc1.fdoc”, by way of example.

A case where the post-assembly document 601 is edited by the editor using the screen 1301 will now be described. In this embodiment, this editing operation is performed by changing the reference-destination entry of the post-assembly document 601.

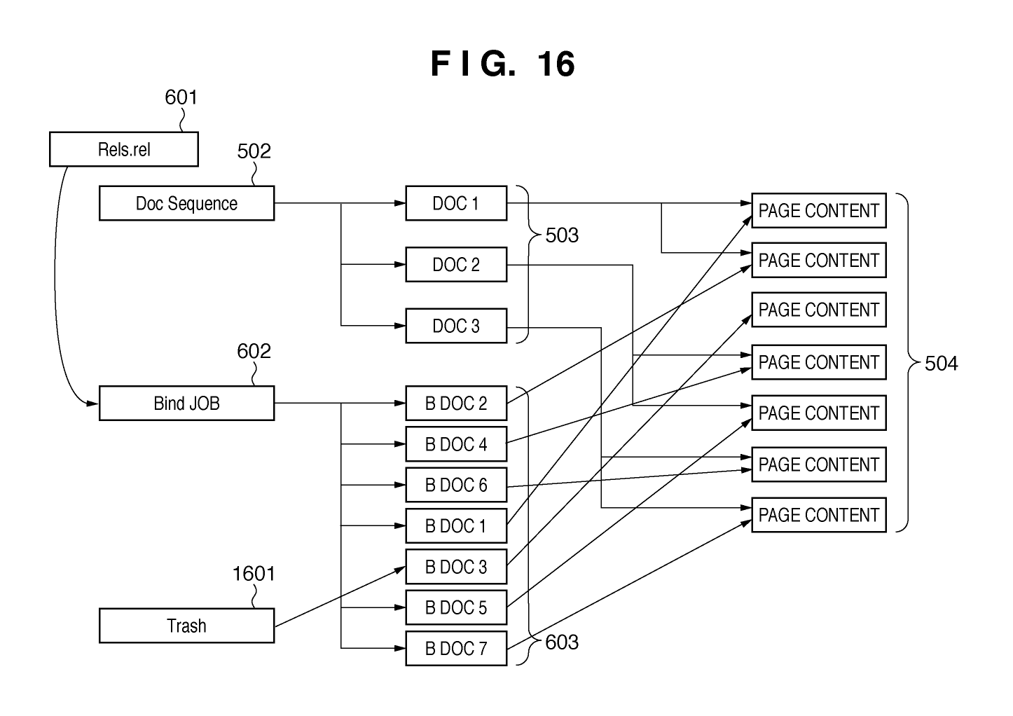

FIG. 16 is a diagram useful in describing an operation for deleting a page. Here a case where the third page has been deleted by the editor using the screens 1301 shown in FIG. 13 will be described. First, in a case where the third page has been deleted, reference from DOC1 to the page content of the third page, reference from B_DOC3 to the page content of the third page and reference from “BindJOB” to “B_DOC3” are deleted. Thus, in this embodiment, page deletion is carried out by deleting the reference-destination entry. In this case, there is no change in the page content of the third page shown in FIG. 16. Instead, in this embodiment, as illustrated in FIG. 16, “Trash” (element 1601) is created anew and a change is made to reference from “Trash” to “B_DOC3” and to reference from “B_DOC3” to the page content of the third page.

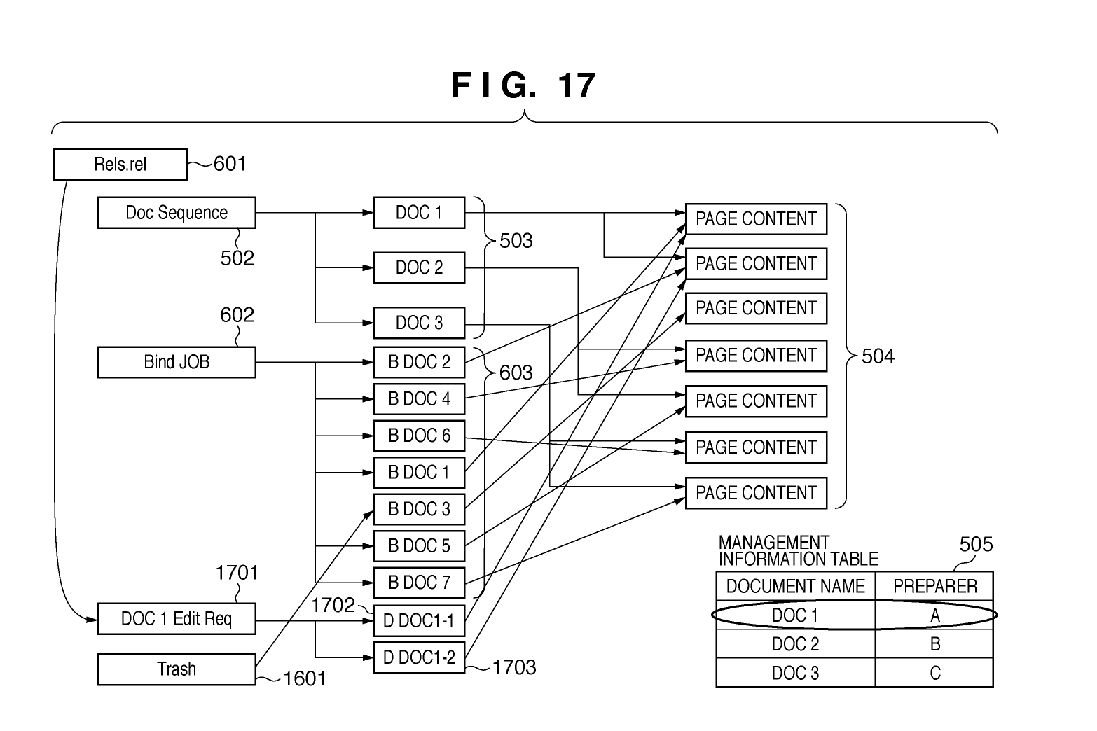

FIG. 17 is a diagram useful in describing a case where editing of a designated page in a document created by a preparer A is requested. Here a case where the editor requests preparer A to edit the first and second pages of the document for A created by preparer A will be described. The “EXTRACT” button 1304 is pressed on the screen 1302 shown in FIG. 13 and the first and second pages are selected as pages for which a revision, etc., is requested on the extracted-document creation screen 1305. In response, “DOC1EditReq” (element 1701) is created anew, as shown in FIG. 17. Further, “DOC1-1” (element 1702) and “DOC1-2” (element 1703) are created anew, and reference from “DOC1EditReq” to “DOC-1”, “DOC-2” is added on. Furthermore, reference from “DOC1-1”, “DOC1-2” to page content of the first and second pages is written in “DOC1-1”, “DOC1-2”. In FIG. 17, it is assumed that the page content of the third page has been deleted. Next, the preparer of the document for A is searched from the management information table 505 that has been stored in a memory, etc., and editing is requested of this preparer.

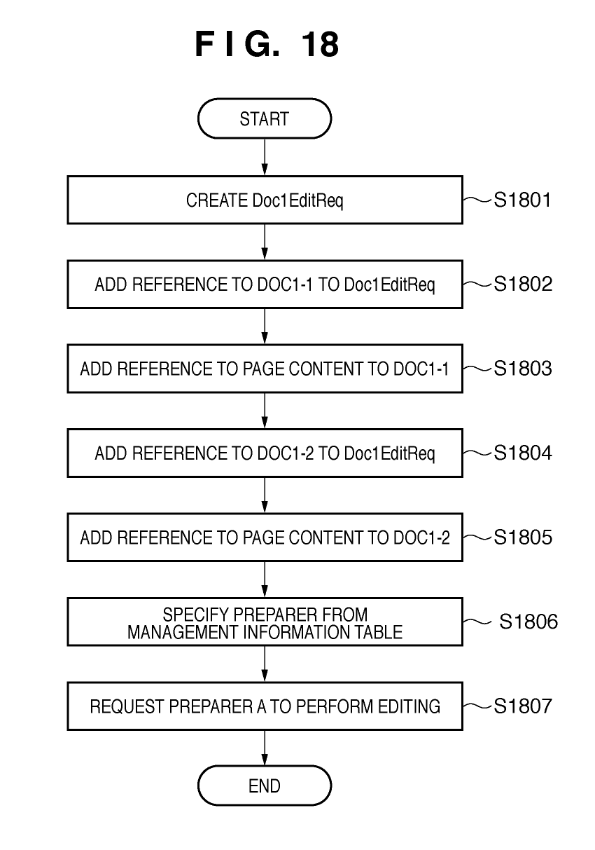

FIG. 18 is a flowchart illustrating processing for requesting editing of a designated page described in FIG. 17. First, at step S1801, “DOC1EditReq” (element 1701) is created within post-assembly document 601. Next, reference to “DOC1-1” (element 1702) is added onto “DOC1EditReq” at step S1802, and reference to the page content of the first page is added onto “DOC1-1” at step S1803. Reference to “DOC1-2” (element 1703) is added onto “DOC1EditReq” at step S1804, and reference to the page content of the second page is added onto “DOC1-2” at step S1805. The preparer is searched from the management information table 505 at step S1806, and an edit request is issued to the searched preparer at step S1807. The edit request may be performed by linking this document management system to a mail server and transmitting mail.

If preparer A is requested to perform editing, then the tree structure is changed and the document for editing (i.e., the post-assembly document that has undergone the required processing) is distributed to preparer A, as described above in connection with FIG. 1. In this case, the tree structure is changed and the editing target is changed over by changing the reference destination of “Rels.rel” (post-assembly document 601).

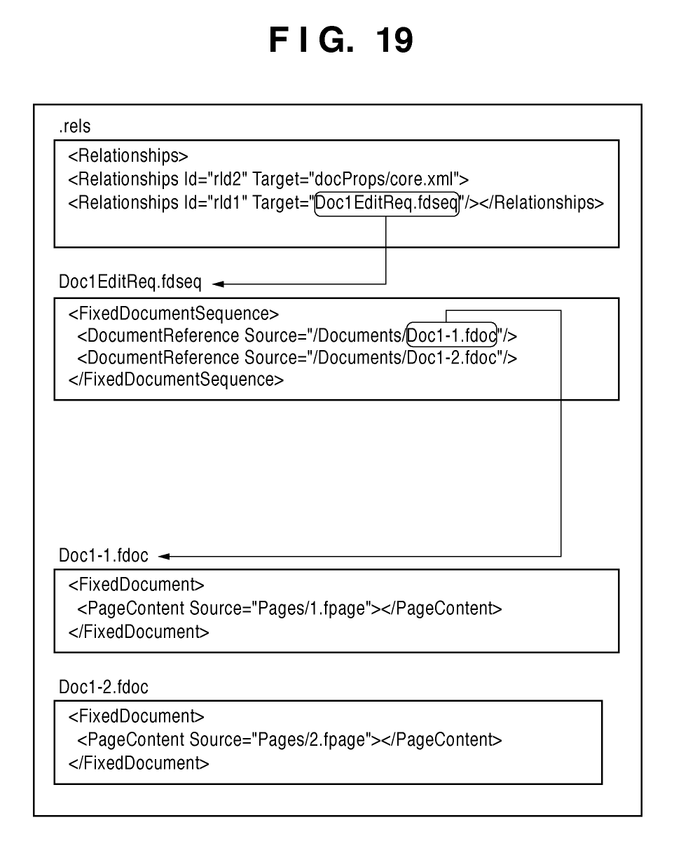

FIG. 19 is a diagram illustrating an example of coding of a post-assembly document in which a reference destination has been changed. As illustrated in FIG. 19, the reference destination in “<Relationships>” is changed to ‘Target=“Doc1EditReq.fdseq”’. Furthermore, “Doc1EditReq.fdseq”, in which reference to all edit-requested page content held by “DOC1EditReq” is written, refers to each “<FixedDocument>”.

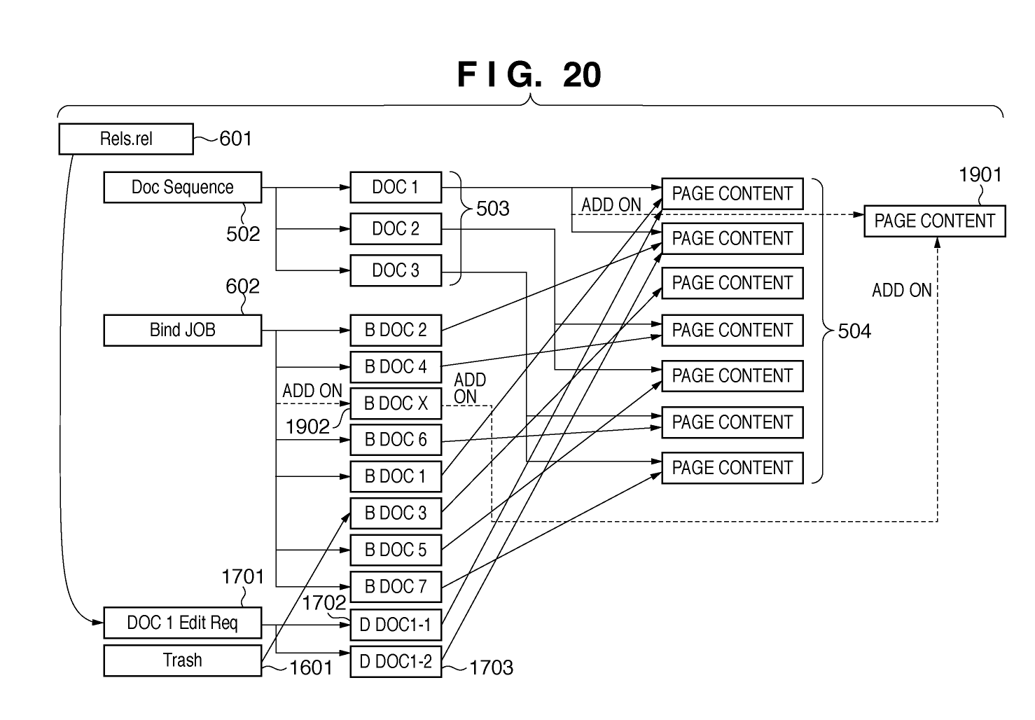

FIG. 20 is a diagram useful in describing a case where a designated page of a document is added on by preparer A. This is a case in which after an edit request is issued by the processing shown in FIG. 17, preparer A adds page content (element 1901), which is a new page, to follow the first page of a document that preparer A created, and then sends the result back to the document management apparatus 104. Preparer A first revises the first and second pages as requested by the editor. At this time a case where the number of pages increases is conceivable. In FIG. 20, an additional page resulting from the revision by preparer A is indicated as page content (element 1901). At the stage where the editor receives the edited document for A from preparer A, there is no reference to the page content (element 1901) from anywhere. Accordingly, the editor adds on the reference to the page content (element 1901). In FIG. 20, reference from “DOC1” (element 503) to the added-on page content (element 1901) is added on. Further, when a page is added on, “B_DOCX” (element 1902) is added on and reference from “BindJOB” (element 602) to “B_DOCX” and reference from “B_DOCX” to the page content (element 1901) are added on automatically. Finally, all of the references from “BindJOB” (element 602) are rearranged.

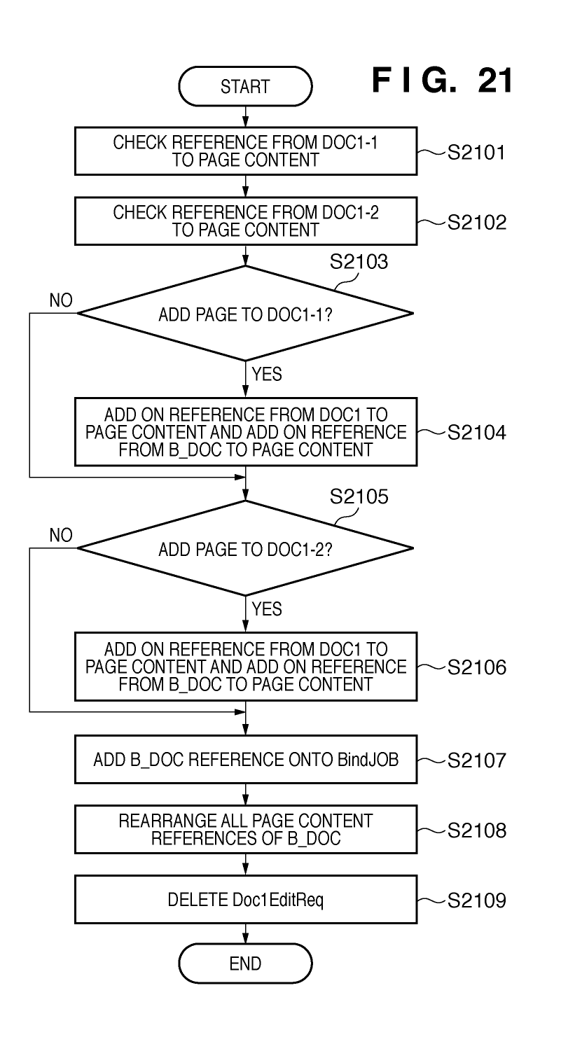

FIG. 21 is a flowchart illustrating processing executed when a designated page of the document for A is added on by preparer A. First, at step S2101, the reference from “DOC1-1” (element 1702) to the page content is checked. Next, at step S2102, the reference from “DOC1-2” (element 1703) to the page content is checked.

Next, at step S2103, it is determined whether a page has been added to “DOC1-1”. If it is determined that a page has not been added on, control proceeds to step S2105. On the other hand, if it is determined that a page has been added on, then, at step S2104, reference from “DOC1” (element 503) to the page content (element 1901) and reference from “B_DOCX” (element 1902) to the page content (element 1901) are added on. Next, at step S2105, it is determined whether a page has been added to “DOC1-2”. If it is determined that a page has not been added on, control proceeds to step S2107. On the other hand, if it is determined that a page has been added on (in this example, it is assumed that the determination is that a page is not added on), then, at step S2106, page reference from “DOC1” and reference from “B_DOCX” are added on. At step S2107, reference from “BindJOB” to “B_DOCX” is added on automatically. Finally, all references from “BindJOB” are rearranged at step S2108. When editing is completed, “DOC1EditReq” is deleted at step S2109.

Thus, in this embodiment, display of an item to be edited can be changed by a change in the description of a reference destination in the tree structure of a structured document in accordance with a preparer or editor. Accordingly, each preparer can be presented with a display solely of a page created by this preparer himself in, e.g., a very large specification. As a result, since it is unnecessary for a preparer to search a very large specification for the portion that the preparer is responsible for, the efficiency of editing work can be improved. Further, the editor can display all of the pages on an editing screen irrespective of the preparers of the source documents merely by changing the description of the reference destination.

Further, the present invention also covers a case where an operating system or the like running on a computer performs some or all of the actual processing in accordance with the designation of program (document management program) codes and implements the functions according to the embodiment by this processing. The present invention is applied also to a case where program codes read from a storage medium are written to a memory provided on a function expansion card inserted into the computer or a memory provided in a function expansion unit connected to the computer. In this case, a CPU or the like provided on the function expansion card or function expansion unit performs some or all of the actual processing based upon the designation of written program codes and implements the functions of the above embodiment by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-056626, filed Mar. 6, 2008, which is hereby incorporated by reference herein in its entirety.

What is claimed is:

1. A document management apparatus for generating a structured document for an editor based upon a structured document for a preparer and editing the structured document for the editor, said apparatus comprising:
a generating unit for generating the structured document for the editor from the structured document for the preparer by additionally providing a document structure, which represents the structure of the structured document for the preparer, with a document structure for the editor that shares pages contained in the document structure; and
an editing unit for editing the generated structured document for the editor.

2. The apparatus according to claim 1, wherein said editing unit rearranges, deletes and adds on pages contained in the structured document for the editor.

3. The apparatus according to claim 1, wherein said editing unit includes a changeover unit for changing over an editing target by changing a reference destination of a root in a document structure between the document structure for the editor and a document structure for the preparer.

4. The apparatus according to claim 3, further comprising a display unit for displaying the editing target to which the changeover has been made by said changeover unit.

5. The apparatus according to claim 1, wherein the structured document is XPS.

6. The apparatus according to claim 1, wherein said editing unit rearranges pages contained in the structured document for the editor by changing the sequence of description of elements that constitute the document structure.

7. The apparatus according to claim 1, wherein said editing unit deletes a page contained in the structured document for the editor by deleting a description of a reference to content of the page without deleting the content of the page.

8. The apparatus according to claim 1, wherein said editing unit adds on a page contained in the structured document for the editor by adding on an element constituting the document structure, content of the page and a reference to the content of the page.

9. A document management method executed in a document management apparatus for generating a structured document for an editor based upon a structured document for a preparer and editing the structured document for the editor, said method comprising the steps of:
generating the structured document for the editor from the structured document for the preparer by additionally providing a document structure, which represents the structure of the structured document for the preparer, with a document structure for the editor that shares pages contained in the document structure; and
editing the generated structured document for the editor.

10. A computer-readable storage medium storing a document management program for generating a structured document for an editor based upon a structured document for a preparer and editing the structured document for the editor, said program causing a computer to perform functions of:
generating the structured document for the editor from the structured document for the preparer by additionally providing a document structure, which represents the structure of the structured document for the preparer, with a document structure for the editor that shares pages contained in the document structure; and
editing the generated structured document for the editor.
